(19) United States
(12) Patent Application Publication
(10) Pub. No.: US 2018/0247246 A1
(43) Pub. Date: Aug. 30, 2018

(54) METHOD AND SYSTEM FOR THE CONSTRUCTION OF DYNAMIC, NON-HOMOGENEOUS B2B OR B2C NETWORKS

(71) Applicant: Englue, Inc., San Diego, CA (US)

(72) Inventors: L. Steven Biafore, San Diego, CA (US); Alejandro Quintero, San Diego, CA (US)

(21) Appl. No.: 15/907,165

(22) Filed: Feb. 27, 2018

Related U.S. Application Data
(60) Provisional application No. 62/464,292, filed on Feb. 27, 2017.

(51) Int. Cl. G06Q 10/06; G06Q 30/02

(52) U.S. Cl. CPC G06Q 10/06375; G06Q 30/0202; G06Q 30/0201

(57) ABSTRACT

A system and method for the construction of dynamic, non-homogeneous business to business (B2B) or business to consumer (B2C) networks provides the ability to accurately predict the future behaviors of entities within a dynamic B2B or B2C ecosystem. The system and method may predict, for example in the B2B context, the likelihood that a given Company B will buy a product and/or service from Company A) that has significant value. The system and method creates and updates dynamic networks of various types of entities or “nodes”: companies, organizations, employees, consumers, investors, educational institutions and other entities that are connected via various types of interactions or “arcs”: B2B transactions, B2C transactions, partnerships, affiances, channel relationships, current employment, past employment, investment, co-worker relationships, personal relationships and other relationships.

### PRIORITY CLAIMS/RELATED APPLICATIONS

This application claims priority under 35 USC 120 and claims the benefit under 35 USC 119(e) to U.S. Provisional Patent Application Ser. No. 62/464,292 filed Feb. 27, 2017 and entitled “Creation, Update and Analysis of Dynamic, Nonhomogeneous Economic Networks”, the entirety of which is incorporated herein by reference.

### FIELD

The disclosure relates to the general areas of Sales and Marketing analytics.

### BACKGROUND

The identification of patterns in networks of companies and the people who are employed by these companies has long played an important role in business to business (B2B) sales and marketing processes. Sales and marketing teams have long worked to understand how best to relate to prospective buyers (in both B2B and business to consumer (B2C) contexts). Salespeople and marketers have long known that understanding who potential buyers trust, who they follow or with whom they compete provides useful context. For example, B2B sales and marketing processes have long included (both manual and automated) ways to understand who works at a company to which they want to sell a good/service, how these people contribute to buying decisions, the types of connections or common ground they (the seller) might share with these people, how the target company relates to other relevant companies (for example, the seller's company, other companies that have bought from the seller, the target's competitors, etc.).

In essence, B2B sales and marketing standard practice has long included the seller seeking to understand the network of people and companies relevant to the target account. Sales people have long used this information to determine who to contact, what message to deliver to each contact, how to leverage other companies and which specific people that might help with the sale, etc. Extensions of this practical model to include other types of entities (such as educational institutions, investors, etc.) are less common but also part of established sales and marketing practice.

There are many ways to precisely define a non-homogenous B2B network. For example, a Sample Network A may be defined to include the following nodes:
a) The largest 1 million companies (as determined by headcount) in a given region (company nodes)
b) All people who have ever been employed by any of the above 1 million companies at any time in the past 10 years (people nodes)

The Sample Network A also may include the following arcs:
a) All of the B2B transactions that were executed within the past 10 years (these arcs connect company nodes to other company nodes)
b) All “current employee” relationships (these arcs connect people nodes to company nodes)
c) All “prior employee” relationship (these arcs connect people nodes to company nodes)

Sample Network A, as defined above, is an example of a static, non-homogeneous B2B network. It is “non-homogeneous” because it includes more than one type of node (companies and people). It is “static” because it does not explicitly include the dimension of time.

FIGS. 1A-1B show an example of the nodes and arcs of a small part of Sample Network A. FIG. 1A shows examples of the companies (which may act as a seller and/or a buyer in the B2B transaction) and people (who may act as employees and/or consumers. FIG. 1B provides an example of a static view of how a set of entities (Companies C₁-C₁₁ and People h₁-h₂₂) relate to one another (as shown by the three different types of arcs including B2B transactions shown as solid lines with arrows from seller to buyer, current employment shown as dotted lines and prior employment shown as dashed lines). Such a view is often interpreted by practitioners in B2B sales and marketing as referring to a specific point in time but is almost always, in practice, a view that mixes data from many different points in time. A “single point in time” is defined as a single “time slice” or “period” (for example, data related to a specific month or quarter).

Each node in FIGS. 1A and 1B refers to a specific individual entity (company or person).

The types of information that a static network can hold include:
1. Which nodes are included in the network (specific identities for each node). With knowledge of the universe of all possible nodes, this specification also indicates which nodes are not included in the network.
2. How the nodes relate to one another (implicitly, if the data is complete or close to complete this also includes how nodes do NOT relate to one another)
3. Details about each node:
   a. Details that are not derived from how the node fits into the network
   b. Details that ARE derived from how the node fits into the network
4. Details about each arc:
   a. Details that are not derived from how the arc fits into the network
   b. Details that ARE derived from how the arc fits into the network

For example, FIG. 1B shows that Company C₂ has completed B2B transactions with Companies C₅, C₆ and C₈. The arrows on the relevant arcs indicate that C₂ is the seller in these transactions. FIG. 1B also shows that people h₂, h₃, h₄, h₅ are current employees of Company C₁ and h₁ is a prior employee of Company C₁.

Current sales and marketing processes include steps (with varying degrees of automation) to search the web for individuals and/or companies related to a target account. This process assembles a picture of the part of the B2B network relevant to the target account. There are now software programs that help with these tasks, allowing users to assemble information from multiple sources.

Many different data elements have been created with the goal of improving the accuracy of matching B2B buyers and sellers (for example, models based upon characteristics of potential buying companies, identification of “buying signals” emitted by potential buyers and analyses that attempt to find people (specific individuals or functional roles) that fit a given profile). All of these are examples of the types of data that may be collected and associated with the nodes and/or arcs in a B2B network. These data elements serve as examples of the kinds of data that can be used as inputs to other systems and methods.

Current processes that create B2B networks do not rigorously address the dimension of time. In some cases, a snapshot of the network at a single point in time is constructed. In the typical case, time is simply ignored and the result is a B2B network view that is assumed to represent a meaningful picture of reality at some point in time but which is in fact a hodgepodge of data that relates to many different points in time.

For example, such a network might include data about some nodes (companies or people, for example) that is current and some data that is several years old, some from last month, etc. Similarly, data for different arcs (seller-buyer relationships, employment relationships, prior-employment relationships, for example) come from a mix of different points in time. Analyzing such a “time ignorant” B2B network often produces misleading or erroneous results but because a subset of B2B entities and relationships are somewhat stable over time, the results are not completely nonsensical. This is one reason why the practice of ignoring time (the technical problem associated with the currently existing systems and methods) has persisted and the need for the invention has not been obvious.

Thus, it is desirable to provide a system and method that constructs a dynamic, non-homogeneous B2B or B2C network that includes time and it is to this end that the disclosure is directed.

### BRIEF DESCRIPTION OF THE DRAWINGS

FIG. 1A illustrates an example of nodes in a static, non-homogeneous B2B network;

FIG. 1B illustrates an example of nodes and arcs in a static, non-homogeneous B2B network;

FIG. 2 illustrates an example of an implementation of a dynamic, non-homogeneous network construction system;

FIG. 3 illustrates more details of the dynamic, non-homogeneous network constructor;

FIG. 4 illustrates an example of a method for creating a dynamic network from a static network specification;

FIG. 5 illustrates an example of the dynamic network structure;

FIG. 6 illustrates an example of a method for modifying data values associated with nodes and/or arcs in the dynamic network;

FIG. 7 illustrates an example of a dynamic context network generated from the dynamic network;

FIG. 8 show an example of some of the forward and backward inter-slice connections that form the dynamic context network;

FIG. 9 illustrates a method to add new values/modify data in the dynamic network; and

FIG. 10 shows data from the example table associated with nodes C₁ and h₁.

### DETAILED DESCRIPTION OF ONE OR MORE EMBODIMENTS

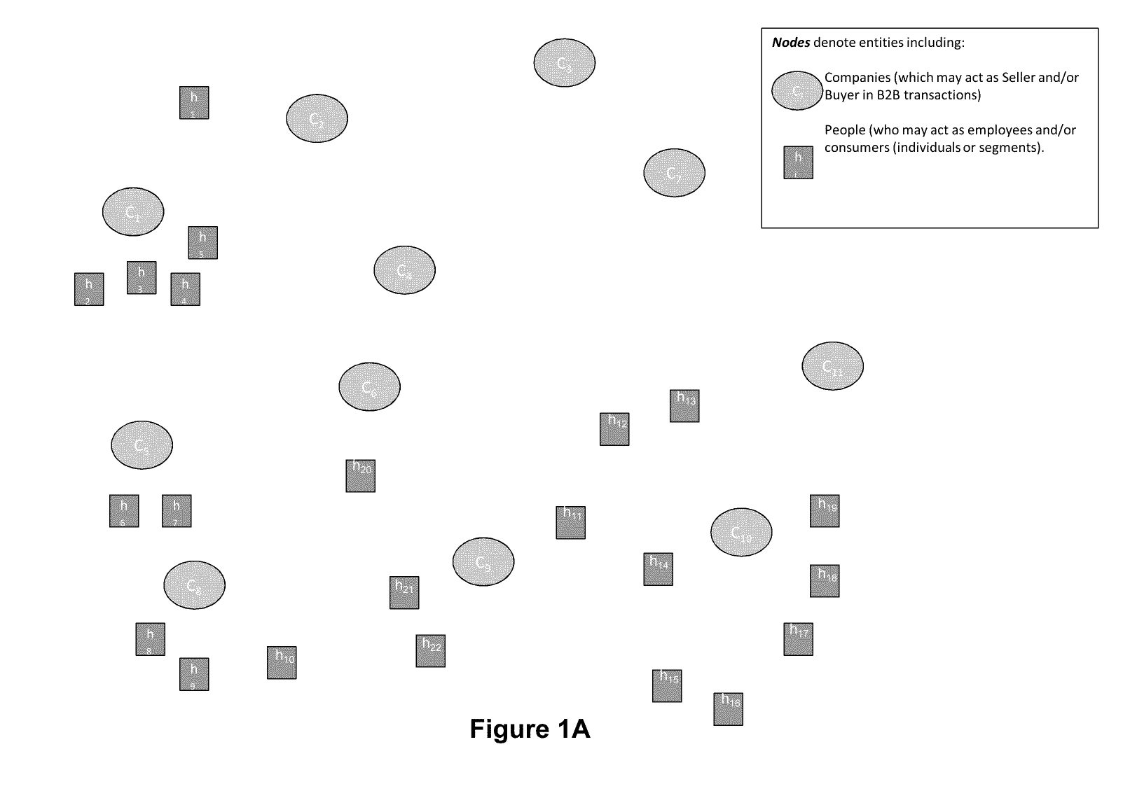

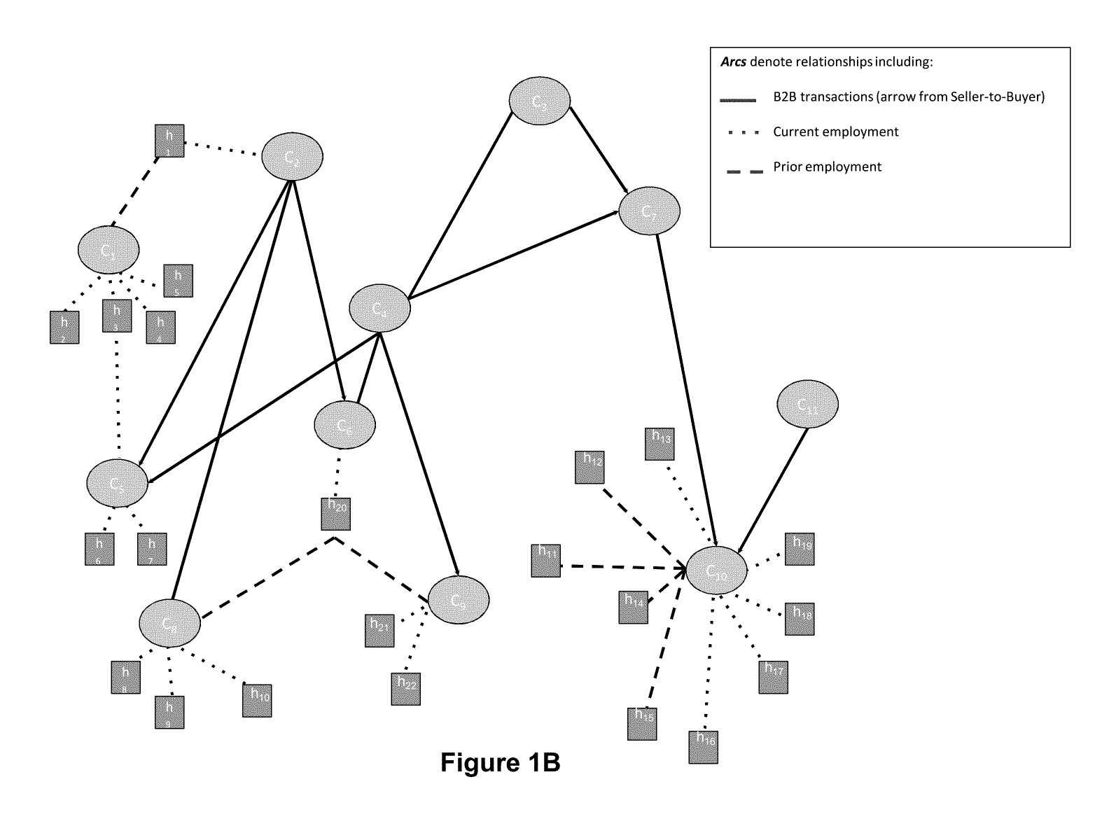

The disclosure is particularly applicable to a system and method for constructing a dynamic, non-homogeneous business to business (B2B) network and it is in this context that the disclosure will be described in the examples below. It will be appreciated, however, that the system and method provides greater utility since the system and method may be used to construct a dynamic, non-homogeneous business to consumer (B2C) network. The system and method provide a technical solution to the above problem and generates dynamic, non-homogenous B2B networks that provide new ways to understand B2B entities and predict their behaviors and the ability to accurately predict the future behaviors of entities within a dynamic B2B ecosystem (for example, the likelihood that a given Company B will buy a product and/or service from Company A) that has significant value. The system and method can create and/or update/modify dynamic networks of various types of entities or “nodes”: companies, subsets of groups within a company (including, for example, organizations, employees, consumers, investors), educational institutions, products or product lines, services or service lines, organizations, people, teams, capital, content, schools, or capital sources and other entities that are connected via various types of interactions or “arcs”: B2B transactions, B2C transactions, partnerships, a merger, an acquisition, affiances, channel relationships, current employment, past employment, investment, co-worker relationships, personal relationships, memberships, friendships, colleague relationships, attendance, certifications, authorships and other relationships. For example, using the static network shown in FIGS. 1A and 1B, the system and method can make that static network “dynamic” by defining a sequence of network “snapshots” for each of a specific set of time-slices where each snapshot has nodes and arcs. For example, by stepping backward in time from a defined point in time (the endpoint) in one-month increments, the system and method changes the nodes and arcs to reflect the way the static network looked at that prior point in time. By defining a specific time span (or start and end time), the system and method arrives at a well-defined, finite set of network snapshots where each snapshot is associated with a specific point in time.

As described below in more detail, the system and method provides a technical solution to construct a dynamic network (the sequential set of snapshots), a way to update the dynamic network data, and a way to add new data to the current dynamic network. This dynamic extension to widely used static B2B networks is a critical advance that enables new types of patterns to be identified and important B2B behaviors to be predicted with increased accuracy. Thus, the system and method provide a way for sales and marketing processes to properly expand the static, or time-ignorant view of the B2B network to explicitly include the dimension of time by creating a dynamic B2B network and then provides unique processes to recognize salient patterns in this dynamic network.

The system and method may provide a dynamic weather map (where the landscape is the B2B world instead of the geographical world) and creates a dynamic picture of the network of interactions in the B2B world, the state of this network at points in the past, the current state of the network and how it will likely evolve in the future (forecasts forward in time to show the likely sequence of future states of the network). Included in this dynamic network view are changes to the network itself (the creation and destruction of nodes and/or arcs). The difference between a static network view of a B2B ecosystem and a dynamic network view of the same ecosystem is similar to the difference between a weather map (showing a snapshot of the weather) and an animated weather-radar “loop” (that shows where how the weather has moved and/or is projected to move).

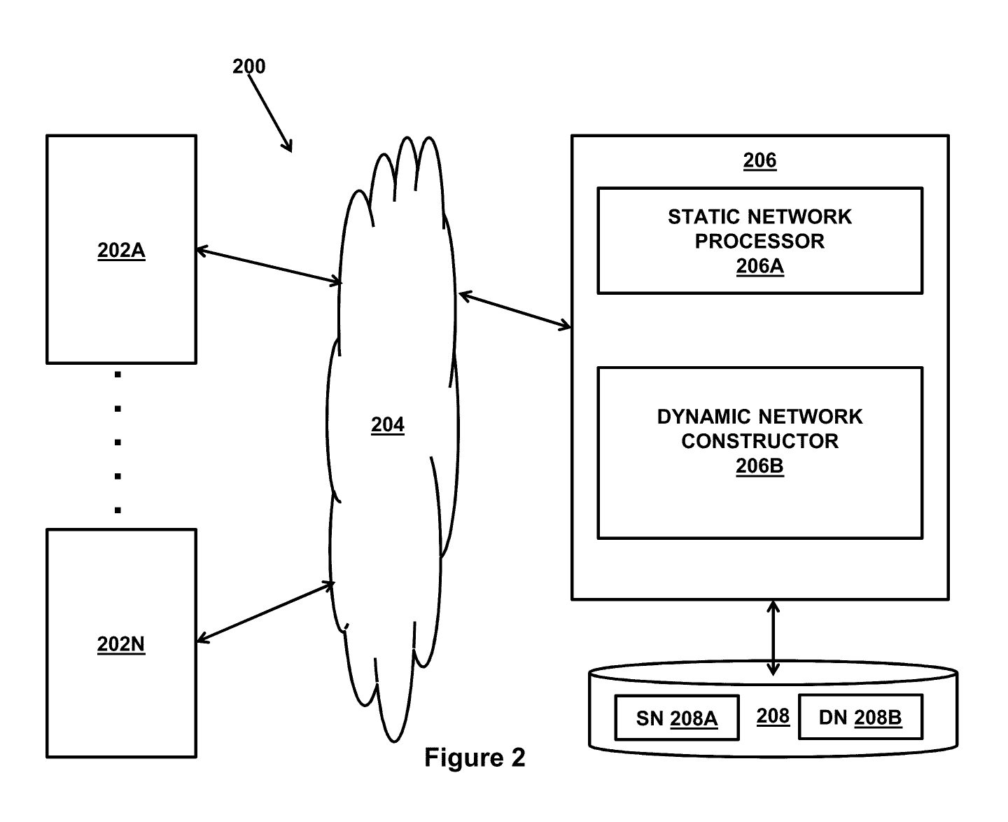

FIG. 2 illustrates an example of an implementation of a dynamic, non-homogeneous network construction system 200 that may construct a dynamic, non-homogeneous network from a static network, may update an existing dynamic network with modification parameters and internal data and/or may update an existing dynamic network with modification parameters and external data as described below in more detail. In the implementation shown in FIG. 2, the system may be implemented using a client/server type computer network architecture although the system may also be implemented on a standalone computer or with other computer architectures.

The system 200 may have one or more computing devices 202, such as 202A, . . . , 202N shown in FIG. 2, that connect and communicate over a communication path 204 to a dynamic network generation backend 206. Each computing device 202 permits a user to connect to and interact with the backend 206 in order to input a static network or static network specification, input dynamic network parameters, input modification parameters or input internal or external data used to update an existing dynamic network and to receive a visualization of the output generated by the system in the form of a constructed dynamic network that can be accomplished using a number of commercially available tools. Each computing device may be a processor based device that may have one or more processors, a memory, a persistent storage device, such as SRAM, DRAM, flash memory or a hard disk drive, a display, input/output devices like a keyboard or mouse or virtual keyboard on a touchscreen of a device and communication circuits that interface with the communication path to communicate data with the backend 206. For example, each computing device 202 may be an Apple iPhone, an Android operating system based device, a personal computer, a laptop computer, a tablet computer, a cluster of dedicated GPUs for a big network hardware optimization and the like. In some embodiments, each computing device may store and execute a browser application, mobile application or application to facilitate the interaction with the backend 206.

The communication path 204 may be one or more wired networks, one or more wireless networks or a combination of wired and wireless networks that communicate data between each computing device 202 and the backend 206. For example, the elements of the communication path 204 may include the Internet, Ethernet, a cellular network, a digital data network, a WiFi network and the like. The communication path 204 may use various data transfer and data communication protocols. For example, the communication path 204 may use TCP/IP, HTTPS or HTTP, JSON, HTML and the like.

The backend 206 may be implemented using a plurality of computing resources, such as server computers, blade servers, processors, database servers, application servers, etc. The backend 206 establishes a connection with each computing device 202 over the communication network 204 may receive input from each computing device that may include a request for an output from the backend, a static network or static network specification, dynamic network parameters, or modification parameters or input internal or external data used to update an existing dynamic network. The backend 206 may also construct a dynamic network or update an existing dynamic network as described below and generate a visualization of the dynamic network or updated dynamic network.

The backend 206 may further comprise a static network processor 206A that has an interface for incoming static network data and may process the incoming static network data and the static network specifications. The backend 206 may further comprise a dynamic network constructor 206B that generates the dynamic network or updates an existing dynamic network. Each or both of the static network processor 206A and the dynamic network constructor 206B may be implemented in hardware or software. When implemented in hardware, the static network processor 206A and/or the dynamic network constructor 206B may be a hardware circuit, such as a microprocessor, microcontroller, a state machine, an ASIC, etc. that is configured to perform the processes described below. When implemented in software, the static network processor 206A and/or the dynamic network constructor 206B may be a plurality of lines of computer code that may be executed by a processor of the computer system that hosts the software so that the processor is programmed and thus configured to perform the various processes and operations as described below.

The system 200 may further comprise a storage device 208, that may be software or hardware implemented storage device, that stores various data used by the system to generate and/or update dynamic networks. For example, the storage device 208 may store one or more static networks 208A (from which a dynamic network may be constructed) and/or one or more dynamic networks 208B (generated by the system or used as input when an dynamic network is updated or modified.) In addition to the system described above in which the backend performs the dynamic network construction or modification, in an alternative embodiment, a mobile device processor may perform the dynamic network construction or modification.

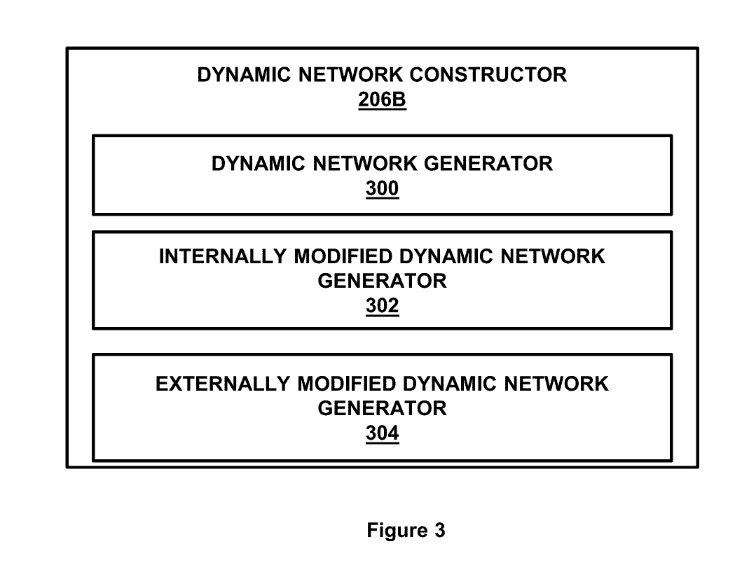

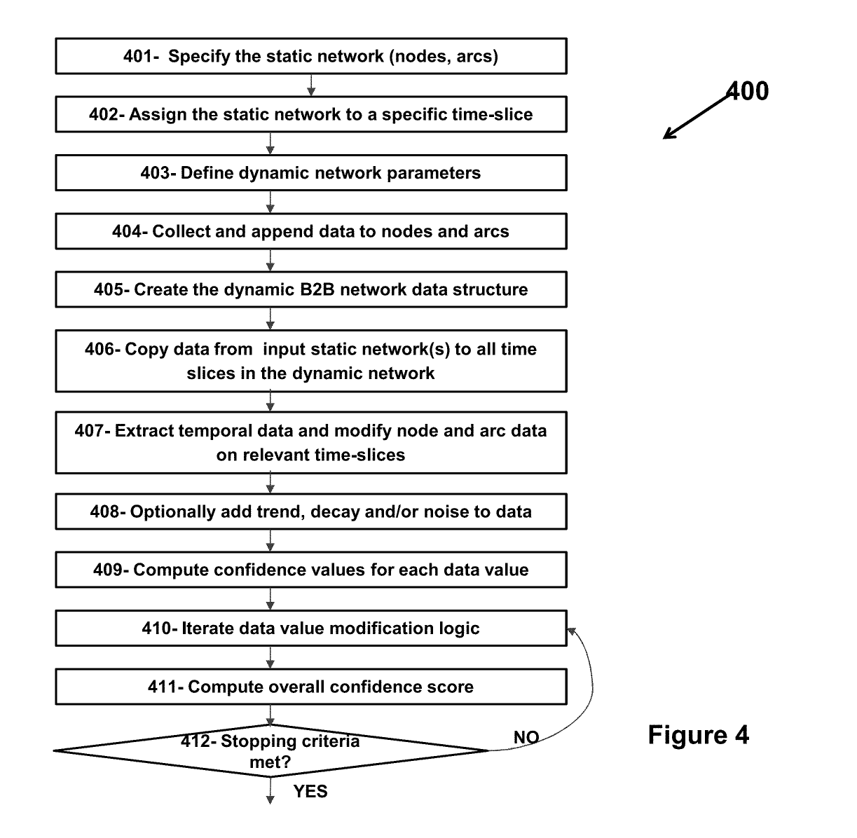

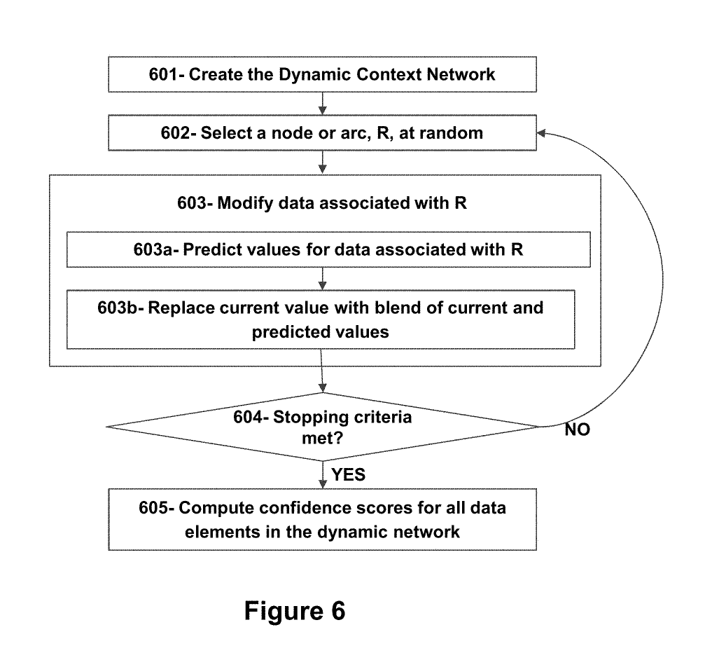

FIG. 3 illustrates more details of the dynamic, non-homogeneous network constructor 206B. The constructor 206B may further comprise a dynamic network generator 300 that receives static network specification (or a static network) and dynamic network parameters and generates a dynamic network. The details of the process performed by the dynamic network generator 300 is discussed with reference to FIG. 4 below. The constructor 206B may further comprise an internally modified dynamic network generator 302 that receives a dynamic network and modification control parameters and generates an internally modified dynamic network and an externally modified dynamic network generator 304 that receives a dynamic network, modification control parameters and external data and generates an external data modified dynamic network. The details of the process performed by these generator 302-304 are discussed with reference to FIG. 6 below. Each element 300-304 shown in FIG. 3 may be part of same code base or may be separate set of computer instructions if the generators are implemented in software and may be separate hardware circuits or implemented in the same hardware circuit if the generators are implemented in hardware.

Thus, the system and method provide a technical solution to:
1. Create a dynamic network (that includes time information for all data) given static network data as input.
2. Modify the dynamic network data (nodes, arcs and descriptive data associated with nodes and/or arcs) in a way that seeks to optimize overall data confidence.
3. Add new data (from external sources) to an existing dynamic network without requiring the network to be newly created (using the dynamic network creation described above).

In order to generate the dynamic, non-homogeneous B2B network or to update the dynamic network, data may be created that may include the following processes:
1. Define the set of nodes to be included (for example, which companies, which people)
2. Define the set of arcs to be included (which relationships exist among the defined nodes)
3. Add data that describes each node (for example, the industry, headcount and revenue of companies; the years of experience and functional expertise of people)
4. Add data that describes each arc (for example, the absolute dollar amount of B2B transactions, the fraction of the seller's revenues derived from the B2B transaction, the fraction of a person's career as an employee of a specific company, etc.)
5. Add the dimension of time by creating a series of static snapshots of the network at regular intervals over a specific time range (for example, one monthly snapshot for each of the past 36 months).

Of these data creation processes, the system and method provides new ways to perform processes 3, 4 and 5. For processes 3 and 4, the system and method enables new types of data to be associated with network nodes and arcs. For example, when a selling company signs up a new customer, the customer may provide new data about their company that was previously not available. For example, historical revenue and headcount information with more precise time information that may be inserted into the dynamic network as described below. Process 5 is a novel process and the system and method provide a technical solution to add the dimension of time.

Many different data elements have been created with the goal of improving the accuracy of matching B2B buyers and sellers (for example, models based upon characteristics of potential buying companies, identification of “buying signals” emitted by potential buyers and analyses that attempt to find people (specific individuals or functional roles) that fit a given profile. All of these are examples of the types of data that may be collected and associated with the nodes and/or arcs in a static B2B network. These data elements serve as examples of the kinds of data that the invention uses as inputs.

Create a Dynamic Network from a Static Network Specification

FIG. 4 illustrates an example of a method 400 for creating a dynamic network from a static network specification. In one implementation, the method 400 may be performed by the dynamic network generator 300 that is thus configured (whether in hardware or software) to perform the processes shown in FIG. 4. Alternatively, the method 400 may be performed by other hardware/software that is configured to perform the processes shown in FIG. 4. The processes shown in FIG. 4 are not conventional or well-known and contain unconventional processes to provide the technical solution described below. For example, the processes of generating the dynamic network with time slices from the static network data, extracting temporal data and modifying data in the dynamic network, using the trend, decay or noise, modifying the data values and computing the confidence scores are a novel ordered combination of processes that are not conventional or well known.

The method may specify the static network (nodes, arcs) (401). The method may receive, as inputs, a specification for a static B2B network. This specification may come in any form that provides the required information. A complete B2B network specification must include:
1. A list of nodes in the network, each node having
   a. A unique ID
   b. Specification of node-type (for example, is the node a company or a person)
   c. Optionally, any other data elements that describe the node (for example, for a company node this data might include headcount, revenue, industry code)
2. A list of all arcs in the network, each arc including
   a. The identities of the nodes that the arc connects (this includes any directionality information if the relationship is directional)
   b. Specification of the arc-type (for example, a B2B transaction, current employment or prior employment)
   c. Optionally, any other data elements that describe the arc (for example, arc magnitude, date or time-span)

The method may then assign the (each) static network to a specific time-slice (select the slice that it most accurately represents even though the data it contains will typically be a mix of many different time-slices) (402). The network specification may optionally include information that associates the network with a specific date, date-range or time period.

The method may then define dynamic network parameters (time span or start-end, number or periodicity of time-slices) (403). The structure of the dynamic network created by the method includes a number of static networks, each one associated with a specific time-slice (for example, a specific year and month). This structure can be specified as a sequential list of time-slices where each slice has a unique ID and a specified starting and ending date-time. Although in practice these time-slices are typically evenly spaced, the invention does not require them to be so.
The method may then collect and append data to nodes and arcs (404). The method may make use of any additional data that is associated with the nodes and/or arcs in the static network specification but it does not require any such information. The method uses the identity information for nodes and/or arcs to append data to each node and/or arc above and beyond any data that is included in the input network specification. The method accomplishes this process via a number of well-known methods including:
1. Looking up node and/or arc information in existing (public and private) databases that hold structured information about the relevant type of entity. For example, accessing company information in well-known sources of company data.
2. Processing unstructured (including text. Image, audio, video data) available on the internet or other public digital data repositories that relate to or describe the relevant nodes and/or arcs.
3. Searching proprietary data sources for information related to nodes and/or arcs.

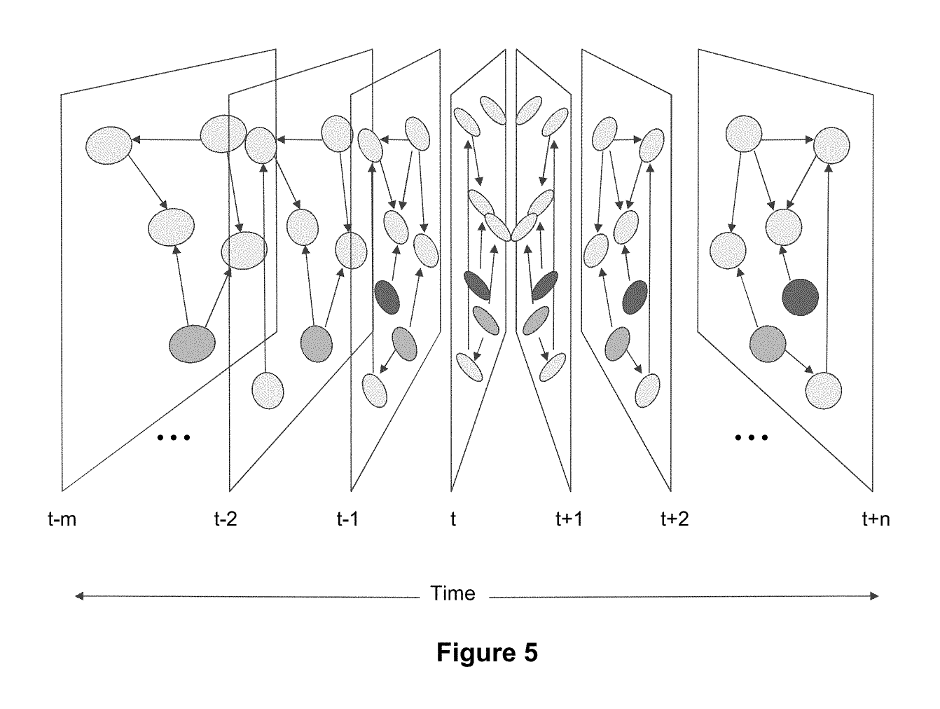

The method may then create the dynamic network data structure (405). More specifically, the method creates a sequential set of static network time-slices based upon the input static network(s), the specified dynamic network parameters (Step 3) and the data appended to the nodes and/or arcs (Step 4). This set of time-slice static networks is the data structure that will serve as a template into which the dynamic network data will be loaded. FIG. 5 shows an example of a dynamic network data structure in which there are nodes and arcs connecting nodes on each time-slice. Note that nodes and/or arcs may occur on some time-slices but not others. Note that nodes that represent the same entity on different time-slices appear in similar relative positions.

The method may then copy node and arc data from input static network(s) to all time slices in the dynamic network (406). The input static network(s) serves as the basis for an initial estimate of the nodes and/or arcs and the data associated with nodes and/or arcs for each static time-slice in the dynamic network. If there is only one input static network the nodes, arcs and data associated with them is copied to each of the time-slices that comprise the dynamic network. The method may include trend, decay and noise functions that modify the values associated with the nodes and arcs. These functions modify data values associated with nodes and/or arcs across the set of time-slices. Trend, decay and noise functions are each controlled by a set of parameters that may either be defined manually or derived automatically from the available data.

If multiple static networks have been input, data values are created for time-slices (exactly as for the single network case) and the values are blended to arrive at the initial data associated with the nodes and/or arcs on each of the time-slices that comprise the dynamic network. Any of a number of well-known estimate blending methods may be used to combine the multiple estimates including weighted average, voting, bagging, boosting, stacking or any combination of these. As with the single static network input case trend, decay and/or noise functions may be applied (either to estimates derived from each input static network, to the blended estimate or both).

The method may then extract any available temporal data associated with node and/or arc-level data from Step 4 and modify node and/or arc data on relevant time-slices accordingly (407). In cases where the input static network(s) specification includes descriptive data at the node and/or arc level and any subset of these descriptive data values has associated time-stamp information the invention includes methods to modify the initial node and/or arc descriptive data values within the time-slices that comprise the dynamic network. For any given data element associated with a given node and/or arc at a specific time:
1. Identify the best-match time-slice (the time-slice that is most aligned in time with the time data associated with the specific data element in question)
2. Update the specific data element value for the specific node and/or arc on that time slice to reflect the data value in question.
3. Optionally propagate the changed value to other time-slices using trend, decay and/or noise functions. (If the value is not propagated at this point, the invention's data improvement step will make use of the updated value.)

The above process is executed for each node and/or arc-level data element for which time data is also provided.

The method may also optionally add trend, decay and/or noise to data values associated to nodes and/or arcs (using the associated time-slice associations from Step 407) (408). The method may then compute a fitness function, such as a confidence score or value, for each data value associated with any node and/or arc across all time-slices (409). The method creates a confidence value for every descriptive data value associated with any node and/or arc that appears on any time-slice comprising the dynamic network. The computation of these confidence values may be a consistency or novelty-score (as can be computed using any of a number of well-known univariate and/or multivariate outlier detection methods including autoencoder reconstruction error, Z-scores, density-based clustering, isolation forests or other statistical metrics) may be based upon external information sources (which may be node and/or arc-specific, node and/or arc-class-specific, or related to any subset of the data values in question) or may be any combination of novelty (internal) and external estimates. Any parameters of the method used to compute confidence scores is included as a modification control parameter of the invention.

All of the processes above (401-409) have served to create the dynamic network including initial values associated with the nodes and/or arcs on the various time-slices and associate a confidence value with each of the data elements associated with these nodes and/or arcs. In general, these initial values will include any number of different intra-slice and inter-slice inconsistencies. Thus, the method may then iterate data value modification logic for nodes and/or arcs across all time-slices (410) to reduce these inconsistencies thus creating a more consistent dynamic network that enables new ways to understand and predict the behaviors of interest. The following are examples of the types of inconsistencies or outliers that can occur in a dynamic, non-homogeneous B2B network:
1. Company A shows a pattern of flat revenue across a 24 month period but over the same time span shows a 10× increase in the total number of B2B transactions.
2. Company B shows large fluctuations in headcount, cycling between 10 and 100 employees every few months. Revenues are growing slowly over this same time span.
3. An extremely small fraction of Company C's employee base has technical education or experience at technical companies, yet nearly all of Company C's competitors have employees with deep technical education and experience.

In each of the above examples, there may be a valid explanation for the pattern (for example, in 1) Company A may have switched to a sales model that gives their product/service away for free (nearly free) in order to attract more customers. In addition, some patterns (1 and 2) are fundamentally dynamic in nature. The patterns simply are not possible to detect when looking at static data (for example, the data on a single time-slice). Other patterns (3) are detectable within static data, but require consideration of broad context, (for example populations of entities such as “companies that compete with Company C”).

In general, detecting inconsistencies and/or outliers requires both a dynamic and broad view of the data. The data value modification logic addresses both dynamic patterns and broad context patterns. The data value modification logic operates on a network object (hereafter referred to as the dynamic context network) derived from the dynamic network described above. The dynamic context network is derived and used to modify data values using the data modification logic as shown in FIG. 6 that will now be described.

Like the method shown in FIG. 5, this data modification method may be performed by the elements of the dynamic network constructor shown in FIG. 3, but may also be performed using other methods. During the data modification of the nodes and/or arcs in the dynamic network shown in FIG. 6, the method may create a dynamic context network (601) using the dynamic network as input. For each node in the network for time-slice t, the method may add a new connection from that node to every node and arc in the network associated with every other time slice. This describes the fully connected embodiment. Other embodiments create fewer inter-slice connections, for example by creating connections only to a limited number of successor and/or predecessor time-slices or by limiting the subset of nodes and/or arcs for which connections are created (for example connecting only to nodes and/or arcs to which the node and/or arc is connected in the network associated with time-slice t).

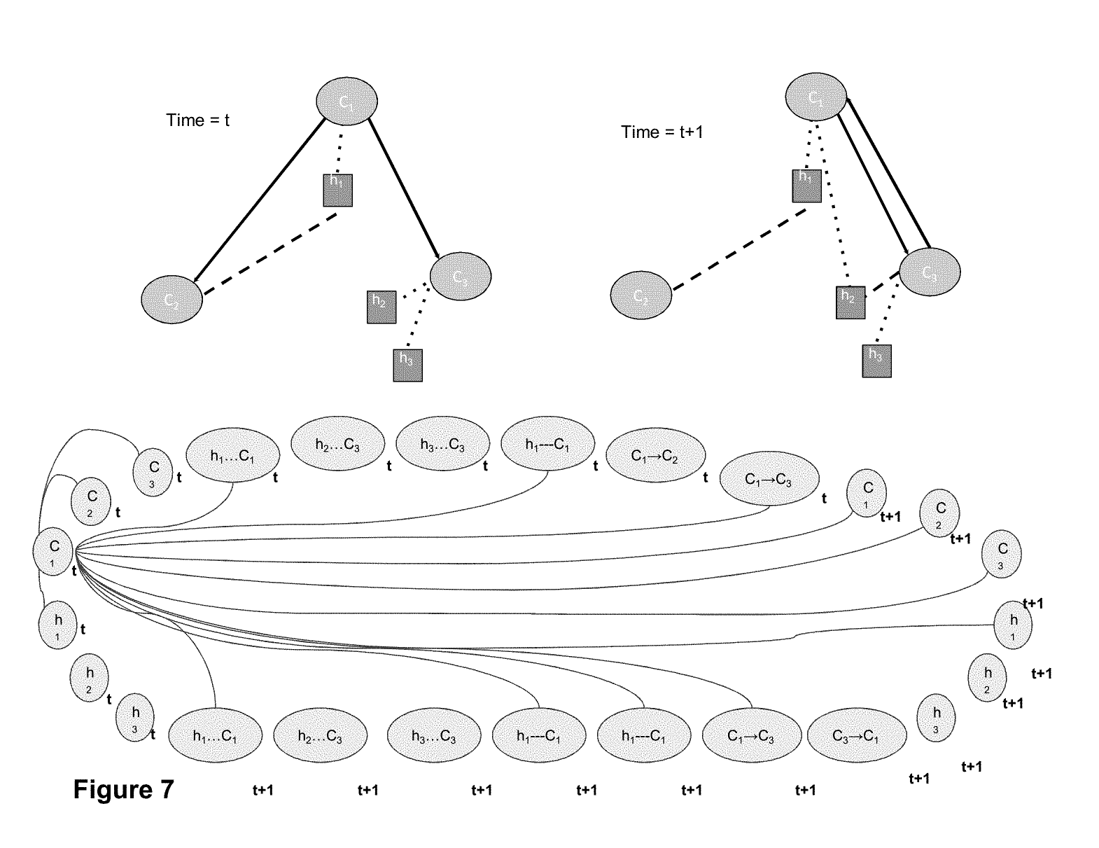

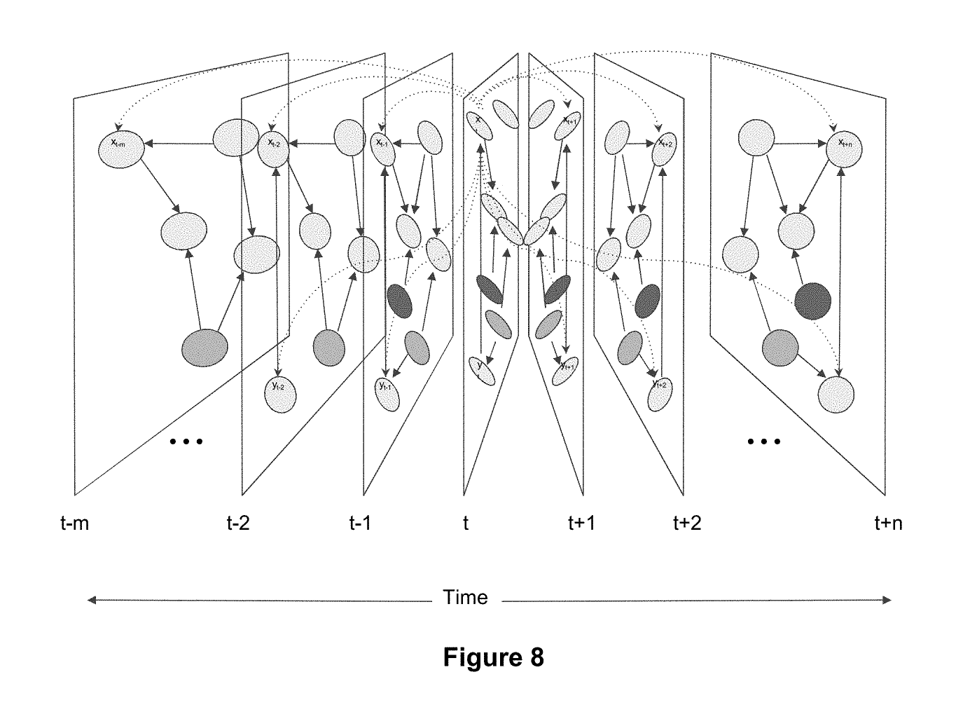

FIG. 7 illustrates an example of a dynamic context network generated from the dynamic network. In this case, the dynamic network comprises two time-slices (at times t and t+1) as shown in FIG. 7. The company (Cᵢ) and people (hᵢ) nodes are connected by the same types of arcs as shown in FIG. 1B (B2B seller-to-buyer transactions, current employment and prior employment). To create the dynamic context network, the method forms a network with nodes representing every node and/or arc on any time slice of the dynamic network (denoted by subscripts t and t+1 in the bottom half of FIG. 7). As described above, the method may connect the nodes in the dynamic context network in many different ways (from fully connected to tightly limited connections). The bottom half of FIG. 7 shows only the connections that involve the node representing Company C₁ at time t (hereafter C₁(t)). In this example, the C₁(t) node is connected to a subset of the nodes in the dynamic context network that are either nodes that C₁(t) is directly connected to, arcs that involve C₁(t), nodes representing C1 in other time-slices, in this case C₁(t+1), or nodes that represent entities to which C₁(t) is connected (but on the t+1 time-slice) or arcs on the t+1 time-slice that involve C₁(t+1). FIG. 8 provides an alternative graphical view of the types of forward and backward in time connections that may be included in the dynamic content network.

There are many other ways to limit the inter-slice connections and connections exist not just from the node to other nodes, but also from the node to other arcs. In this way, arcs in the dynamic network become a new type of node in the dynamic context network. In one embodiment, the existence of an arc (which may admit degrees or may be binary) is treated as a descriptive data element for the dynamic network arc (which is treated as a node in the dynamic context network). Limiting connections is sometimes beneficial in practice because the number of connections in a fully-connected dynamic context network may grow very large. Similarly, for each arc in the network for time-slice to add a new connection from that arc to every node and arc in the network associated with every other time slice. This describes the fully connected embodiment. Other embodiments create fewer inter-slice connections, for example by creating connections only to a limited number of successor and/or predecessor time-slices or by limiting the subset of nodes and/or arcs for which connections are created.

Returning to the data modification method in FIG. 6, the method may randomly select a node or arc, R, from the set of all possible nodes and arcs in the dynamic network (602). The method may then, for the selected node or arc, R, execute the following process (603) to modify the descriptive data associated with the node or arc (any subset of this descriptive data may be selected for update):
a. Predict the value of the specific descriptive data element(s) using as inputs the values for any subset of the descriptive data associated with any subset of the nodes to which R is connected in the dynamic context network, including confidence score data at any/all levels of granularity (603a). This prediction may use any of a number of well-known methods including naive bayes, regression, backpropagation neural networks, autoencoding and/or deep learning models. Alternatively, instead of predicting the value of the specific descriptive data element, we may estimate the probability that each of a set of possible values are correct. The result of this step is a suggested improved value for the specific descriptive data value for R.
b. Modify the value of the descriptive data for R so that it is a function (blend) of the current value and the suggested new value (603b).

The method may then repeat processes 602, 603 until stopping criteria are reached (604—the same stopping criteria process 411 described below) or a specified number of values have been modified (a parameter of the method). Stopping criteria may include convergence (value changes are increasingly smaller over time and/or are less than some specified threshold), number of iterations, amount of processing time or any of a number of other well-known stopping criteria.

The method 600 in FIG. 6 may then compute the confidence score for each descriptive data element associated with each node and/or arc in the dynamic network (605). This confidence score is typically produced as part of the value modification logic (603) but if it is not an additional step is completed to produce these confidence scores. Any of a number of methods may be used to estimate confidence including naive bayes, regression, backpropagation neural networks, autoencoding and/or deep learning models. In one embodiment the invention builds an autoencoder (using any of a number of well-known methods) and applies a scaling function to the autoencoding reconstruction error to compute the confidence scores. Thus, the data modification of the data in the dynamic network has been performed.

Returning to FIG. 4, the method may then compute overall confidence score (a function of the confidence in each data value associated with each node and/or arc, optionally weighted) (411) and thus compute confidence values for all of the values associated with all of the nodes and arcs across all time-slices (because the updates we made in process 410 impact not just the confidence in the updated values, but also the confidence in all other values to which the updated values provide relevant context). The overall confidence score summarizes the (potentially) large number of confidence scores for descriptive data elements associated with the arcs and/or nodes in the dynamic network. The overall confidence score may also serve as an input to functions that produce stopping criteria. Any of a number of functions may be applied to the confidence scores associated with descriptive data values associated with the nodes and/or arcs in the dynamic network to compute the overall confidence score. Examples of functions that derive an overall confidence score from finer-grained confidence scores include median, median change from prior iteration(s) to the latest confidence score, and higher derivatives (rates of change, rates of rates of change etc.) of confidence curves. Any number of levels of aggregations may be used in the function that computes the overall confidence score. For example, data-element-level confidence scores for a given node (or arc) may be aggregated to the node (or arc) level, to the node (or arc)-cross-section level (the set of dynamic network nodes that refer to the same entity but on different time-slices, the node (or arc)-class-level, etc.

The method may then repeat processes 410, 411 until the overall confidence score is maximized, converges or meets specified stopping criteria (412). The overall stopping criteria may include convergence (overall confidence score changes are increasingly smaller over time and/or are less than some specified threshold), number of iterations, amount of processing time or any of a number of other well-known stopping criteria.

Modify the Dynamic Network Data

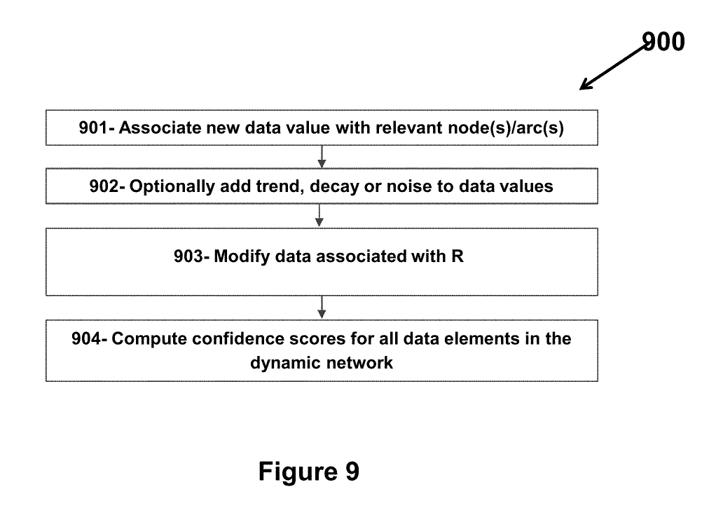

Now, the modification or updating of the data in the dynamic network will be described. These methods may be performed by the internal modified dynamic network generator 302 and/or the external modified dynamic network generator 304, but may also be performed using other systems and hardware or software. The method 900 is shown in FIG. 9. The processes shown in FIG. 9 are not conventional or well-known and contain unconventional processes to provide the technical solution described below. For example, the processes of using the trend, decay or noise, modifying the data values and computing the confidence scores are a novel ordered combination of processes that are not conventional or well known.

The method 900 may associate the new data value with the relevant node(s)/arc(s) (901). Over time it may be the case that new data becomes available for some subset of descriptive data values associated with nodes and/or arcs in a dynamic network. The method can in all cases include these values by simply adding them to the external or internal input (one or more of the static network specifications used as input to the system and method.) Depending upon the size and complexity (for example, the number of nodes, arcs and/or associated descriptive data values) this approach to add data may be practically difficult due to cost, time and/or effort. However, the method and system provide a technical solution to this problem of adding data and provides a less costly way to include new values in an existing dynamic network in the following manner:
1. For each of the new data values to be added, identify the node(s) and/or arc(s) with which the data is associated. The new data may or may not include time information (that would indicate which time-slice(s) in the dynamic network to update).
   a. If time information is included with the new data, find the specific time-slice(s) to which the new data relates.
   b. If time information is not included, the invention must estimate the time information first, and then find the time-slice(s) to which the new data relates. This may be accomplished using any of a number of well-known methods such as associating the value on every possible time-slice and choosing the time-slice that maximizes smoothness or other curve fitting criteria. The invention's confidence score may also be computed for all possible time-slice associations and the highest confidence association used as the time information estimator.
2. For each of the new data values to be added estimate a confidence score.
   a. If the new data includes a confidence score then use the included value.
   b. If the new data does not include a confidence score the invention must estimate a confidence score (using any of a number of well-known methods as described above, including autoencoder reconstruction error)
3. For each new data value to be added:
   a. If a value for the same data element already exists and has a value (same node and/or arc, same descriptive data element) then apply any of a number of functions to blend the existing value and the new value (for example, a weighted average where the weights are the confidence scores of the current and new values)
   b. If a value does not already exist in the current dynamic network, copy the new value and its confidence into the dynamic network data structure.

Returning to FIG. 9, the method may optionally add trend, decay and/or noise to data values associated to nodes and/or arcs (902). In particular, whenever new data values are added to an existing dynamic network we may optionally apply trend, decay and/or noise functions is the same manner as described above for process 408. The method may then optionally execute the value modification logic (903) in the same manner as described above for process 603. Although not required, it may often be beneficial to execute the value modification logic on all values for any node and/or arc for which new data was added. This helps to ensure that the newly added values are consistent within the context of the other data values associated with the updated node(s) and/or arc(s) as well as within the context of the entire network. The method may execute the value update logic for just the updated node(s) and/or arc(s) or may expand the context to include any other subset of nodes, arcs and/or data values in the dynamic network. For example, the method may update all nodes and/arcs that represent any of the updated entities on any time-slice, or we may choose to update all data values for all nodes and/or arc to which any updated arc is directly connected.

The method 900 may then compute overall confidence score (a function of the confidence in each data value associated with each node or arc, optionally weighted) (904). In particular, the method may compute confidence values for all of the values associated with all of the nodes and arcs across all time-slices (because the updates impact not just the confidence we have in the newly added values, but also the confidence we have in all other values to which the updated values provide relevant context) in the same manner as described above for process 411.

### EXAMPLE

Now, to further illustrate the above unconventional processes and the novel ordered combination of processes and elements, an example is provided that uses the system and method described above to create and improve data within a dynamic B2B network starting with the static network shown in FIGS. 1A and 1B.

Process 401—Specify Static Network

Sample Network A is a static network of companies and employees (as described above and as shown in FIGS. 1a-1b). Specific descriptive data elements for each of the nodes within Sample Network A are shown in Table 1 below (company nodes and person nodes have different descriptive data elements).

| Node | Headcount/Months | Industry/Functional |
|---|---|---|
| (Company) | Experience | Area |
| C₁ | 25 | Financial Services |
| C₂ | 100 | Human Resources |
| C₃ | 50 | Software |
| C₄ | 10 | Financial Services |
| C₅ | 50 | Software |
| C₆ | 250 | Financial Services |
| C₇ | 5 | Marketing |
| C₈ | 25 | Legal |
| C₉ | 35 | Software |
| C₁₀ | 75 | Software |
| C₁₁ | 350 | Software |
| h₁ | 120 | Engineering |
| h₂ | 60 | Finance |
| h₃ | 24 | Marketing |
| h₄ | 24 | Marketing |
| h₅ | 12 | Sales |
| h₆ | 36 | Sales |
| h₇ | 84 | Engineering |
| h₈ | 25 | Engineering |
| h₉ | 240 | Engineering |
| h₁₀ | 396 | Engineering |
| h₁₁ | 24 | Finance |
| h₁₂ | 60 | Sales |
| h₁₃ | 96 | Marketing |
| h₁₄ | 60 | Marketing |
| h₁₅ | 120 | Engineering |
| h₁₆ | 120 | Engineering |
| h₁₇ | 120 | Marketing |
| h₁₈ | 180 | Marketing |
| h₁₉ | 204 | Engineering |
| h₂₀ | 20 | Engineering |
| h₂₁ | 90 | Marketing |
| h₂₂ | 36 | Engineering |

This static network specification does not include explicit time information for any of the data elements.

Step 2—Assign Static Network to a Specific Time-Slice

For purposes of this example, Sample Network A (in FIGS. 1A and 1B) and the descriptive data that appears in Table 1 are most closely associated with January 2017. Unless explicitly stated otherwise, all of the data in this static network specification is assumed to relate to the January 2017 time period and assigned to that time-slice of the soon to be generated dynamic network.

Step 3—Define Dynamic Network Parameters

For purposes of this example, the dynamic network should begin in January 2013 and extend to January 2018 with time-slices spaced at monthly intervals.

Step 4—Collect and Append Data to Nodes and Arcs

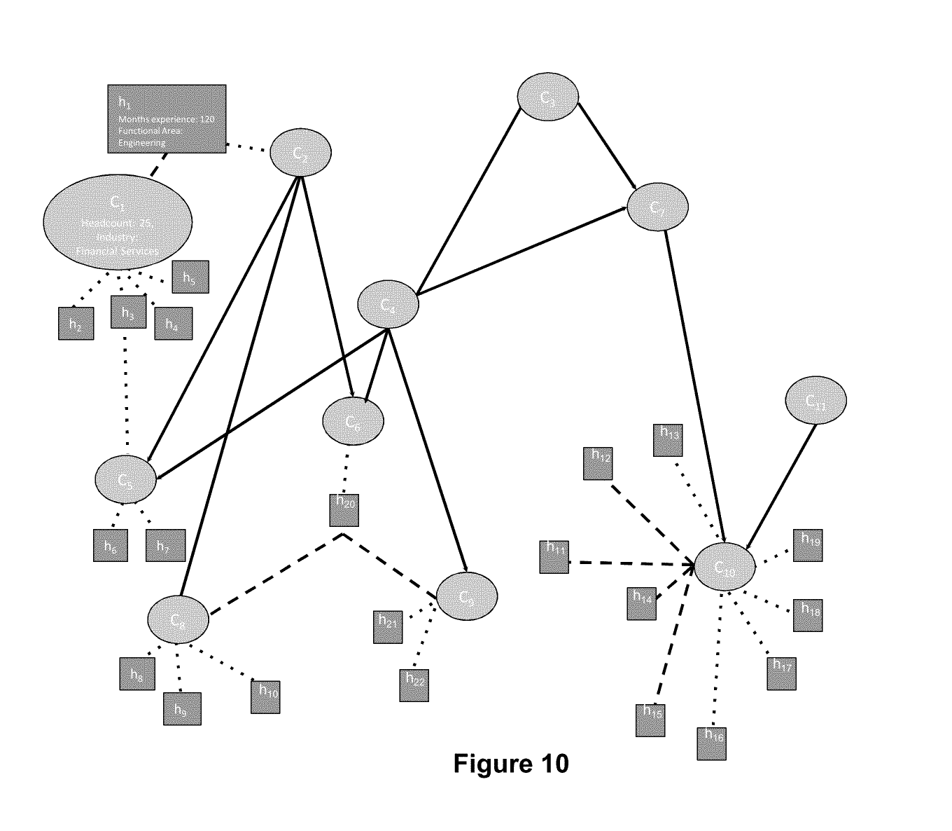

In this example, the data in Table 1 above may be appended to the nodes in the network. For example, as shown in FIG. 10, the descriptive data may be added to any node and/or arc and this figure shows data from the table associated with nodes C₁ and h₁ that has been appended to the static network in FIG. 1B.

Step 5—Create Dynamic Network Structure

Based upon the definitions of node and arc types and the descriptive data associated with individual nodes and arcs in Sample Network A, the system and method creates a set of monthly time-slices of the same structure starting with January 2013 and Ending with January 2018.

Step 6—Copy Data from Static Network to Time Slices

All nodes and arcs specified in Sample Network A may be copied onto each of the time slices and then the descriptive data supplied in Table 1 is added to the network. For example, this is shown in FIG. 5, but with the detailed structure as shown in FIG. 10. In this example, trend functions may be applied to the descriptive values in Table 1. For person nodes, the “months of experience” values may be decremented by 1 month for each time-slice prior to January 2017, and increment by 1 month for each month after January 2017. In this example, “function specialty” data values are not modified. For time slices where the person's “months of experience” is less than zero, the person node is removed from the network on that time slice.

For company nodes, an industry median monthly growth rates may be applied to estimate headcount for time-slices that occur after January 2017 and apply these industry median rates in reverse for time-slices that occur before January 2017. If derived headcount becomes less than a threshold value (2 employees), the headcount may be set to this minimum value. The industry associated with company nodes is not modified and, in general, any trend function may be used.

Step 7—Extract Temporal Data to Modify Node and Arc Data

To illustrate incorporation of data-element-specific time information assume high-confidence data that indicates that Company C₂ had headcount of 90 in January 2015. Also assume that the median growth trend function applied in Step 6 of this example produced an estimated January 2015 headcount for Company C₂ of 70. The method may blend these values (using any weighting but we apply equal weight in this example) and modify the January 2015 headcount value for Company C₂ to equal 80. The method then recomputes the growth rate for Company C₂ based upon the updated January 2015 headcount (80) and the headcount specified in Table 1 (100, which related to January 2017). The method may then modify the headcount values for Company C₂ on all time-slices to reflect this updated trend function.

Step 8—Apply Trend, Decay and/or Noise to Data

In this example, we choose not to apply any further trend, noise or decay functions to the node and/or arc data in the dynamic network.

Step 9—Compute Confidence Values

The method may compute initial data-element-level confidence values for all data elements associated with the nodes and/or arcs in our example dynamic network. In this example, the method assigns the same confidence to all values in the January 2017 time-slice based upon type of data. For example, a confidence of 0.7 (for this example, confidence values range from 0 to 1, 1 indicating perfect confidence) is assigned to all headcount values for all Company nodes and a confidence of 0.5 is assigned to all industry values. For person nodes, a confidence of 0.7 may be assigned to all months-of-experience values and confidence 0.5 to all functional specialty values.

The method may then apply a decay function to these confidence values to compute confidence values for the analogous values on time-slices before and after January 2017 based upon the number of months separation the time-slice has from the January 2017 time-slice. In this example, confidence erodes by 2% each month.

For the data element for which we had specific time information (headcount for Company C₂ for January 2015, see process 407 of this example), the method uses the confidence value specified for this data point for the Company C₂ headcount for the January 2015 time-slice. The method may then re-compute confidence values forward and backward from January 2015 and apply a function (in this example we use the “maximum” function, but any of a number of blending functions may be used) to combine the existing confidence value and the new one computed using January 2015 as the center point for the confidence decay function.

Step 10—Iterate Data Value Modification Logic

At this point, an initial dynamic network exists with a set of initial values for all descriptive data associated with all nodes and arcs on each of the time-slices. Each time-slice is itself a network and each of the nodes and arcs in each of these networks has a set of descriptive data values and a confidence score associated with each of these values. The dynamic context network is created as described above using the dynamic network (built as described above) as input. In this example, the inter-slice connections this dynamic context network is limited to include the following connections:
1. The method connects any node for a given entity, x (x is a company or person) to all nodes on all time-slices that represent entity x (same company or same person, just at different times)
2. If a node for entity x is connected to another node that represents an entity y in any of the time-slices, the method connects the node to all nodes on all time-slices that represent entity y. In other words, if a node represent entity x, and any node representing entity x is connected to any node representing entity y on any time-slice, then the method connects that node to all nodes, on any time-slice, that represent entity y.
3. The method connects any node to itself. This is useful in cases where a node has multiple different associated data values (for example, headcount and revenue) to ensure that these values are consistent.

The method may then select at random, one node or arc, z, from one of the time-slices comprising the dynamic network and then select one of the descriptive data elements associated with node or arc, z and create a model to predict that value. This model may use as input any inputs derived from any subset of the values associated with the nodes to which z is connected in the dynamic context network (including values and confidence estimates for values). The training data for this model will typically include many instances of similar values being predicted from many similar nodes, where similarity includes the place that node z holds in the dynamic network (nodes with similar number and types of connections, nodes with connections to similar types of other nodes, for example).

To illustrate how this model works, assume that the method randomly selected the node on the December 2016 time-slice associated with Company C₅, and assume that the descriptive data we selected was headcount. This node has a headcount value slightly less than the headcount value given in Table 1 because the December 2016 slice occurs before the January 2017 slice and the trend function was applied to estimate the headcount for Company C₅. Let's assume the current value for C₃ headcount on the December 2016 slice is 47 and that the model built to predict Company C₃ December 2016 headcount produced an estimate of 49.5. This model, which may, for example, have been trained estimate headcount using a training dataset that had records for similar nodes (for example, software companies with 10<headcount<100, with relatively inexperienced employees). The model may utilize any of a number of patterns to estimate headcount, for example, it may learn that at software companies with highly experienced staff headcount tends to grow more slowly than it would at similar companies with inexperienced staff. Note that in this example, the node whose value is being updated (C₃ on the December 2016 slice) has representative nodes on many time-slices one of the strongest influences on the predicted value will be the headcount values for C₃ on these other slices, especially the ones that are close in time. One way to think of this is that the headcount value we are trying to estimate has many constraints both on the December 2016 time-slice and on many other time-slices. The model that predicts its value is finding a way to simultaneously meet all of these constraints. Thus, for example, if C₃ has a headcount value of 48 (with high confidence) associated with its nodes on the November 2016, October and September time slices coupled with headcount of 50 on the January 2017 and February 2017 time slices, the method is likely to see a model that produces and estimate at or above 48 for C3 headcount on the December 2016 time-slice. It is in this way (with far more complex patterns that occur when looking at how B2B networks evolve over time) that the system and method slowly iterates to improve the overall internal consistency of all of the values associated with all of the arcs and nodes (including their existence on any given time-slice). Values that “just don't make sense” are slowly modified to make more sense within the larger context.

In our example, given the new estimate of 49.5 for C₃ headcount on the December 2016 slice, the method moves the network value for headcount for this node up by a small amount (the specific amount is controlled by a learning rate parameter). Let's assume that the learning rate places the new value for C3 headcount on the December 2016 time-slice at 48. The method updates the value accordingly, make a new random node or arc selection, select a new associated data value and adjust it. The method repeat this until the stopping criteria is achieved. Let's assume that the stopping criteria to be 1000 random updates. Once reached, we continue to process 411. The method may also increase the confidence score by a small percentage (a modification control parameter).

Step 11—Compute Overall Confidence Score

The method may then compute the overall confidence score for our updated dynamic network by aggregating the updated confidence scores of the data values associated with the nodes and arcs in our dynamic network. In this example, the method computes confidence scores for all values using autoencoder reconstruction error. The method may use any of a number of aggregation functions, but in this example the average confidence score of the entire population of values in our dynamic network. If this population is large compared to the number of random updates we made since the prior overall confidence score then the change will be small.

Step 12—Stopping Criteria Met?

The method can use any of a number of stopping criteria, but in this example the method stopped when 2000 iterations of value update cycles were completed (repeated batches of process 410).

If Sample Network A (which itself had 11 companies, 22 people and 37 arcs of various types, so a total of 70 node and arcs), then the method created a dynamic network with 60 time-slices with approximately 4200 total nodes and arcs across all time slices and each node/arc has approximately 2 associated values. Thus, the constructed dynamic network has about 10,000 values that may be adjusted for internal consistency (counting existence of nodes and arcs). The method may also make 1000 random changes, pause and recalculate overall confidence and repeat this 2000 times (thus a total of 2 million updates). Note that the system and method is agnostic as to the structure of the network (for example, the number of connected subgraphs that the overall network has) and there is no specific network structure that is required other than the existence of at least two nodes and a non-zero number of arcs.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method, comprising:
receiving a static network specification, the static network specification having a plurality of nodes and a plurality of arcs, each node representing an entity associated with a business and each arc connecting two nodes in the static network and representing a type of interaction between the two nodes in the static network; and
creating a dynamic business network based on the static network specification, the dynamic business network having a plurality of nodes that correspond to the plurality of nodes of the static network, a plurality of arcs that corresponds to the plurality of arcs of the static network and a plurality of time slices that each have a set of nodes and arcs for a time period derived from the plurality of nodes and arcs of the static network.

2. The method of claim 1, wherein receiving the static network specification further comprises one of: (a) receiving a static network specification for a single static network and (b) receiving a static network specification for a plurality of static networks and wherein creating the dynamic business network further comprises combining the plurality of nodes and arcs for each static network into the plurality of nodes and arcs for the dynamic business network.

3. The method of claim 1, wherein the static network specification further comprises at least one piece of data relating to more than one time period represented by the time slices in the dynamic business network.

4. The method of 1, wherein creating the dynamic business network further comprises automatically assigning the plurality of nodes and arcs of the static network specification to a predetermined time slice of the dynamic business network.

5. The method of claim 1, wherein creating the dynamic business network further comprises applying one or more of a trend, decay and noise function to a piece of data in the dynamic business network.

6. The method of claim 1, wherein each node represents one of a company, a group within a company, a product, product lines, a service, service lines, an organization, people, a team, capital, content, a school and a capital source.

7. The method of claim 6, wherein each arc represents one of a business-to-business transaction, a partnerships, a merger, an acquisitions, an investment, employment, prior employment, a membership, a friendships, a colleague relationship, an attendance, a certification, a business to consumer transactions and an authorship.

8. The method of claim 1, wherein the static network further comprises one or of a business to business static network and a business to consumer static network.

9. The method of claim 1 further comprising modifying one or more pieces of data in the dynamic business network.

10. The method of claim 9, wherein modifying the one or more pieces of data in the dynamic business network further comprises changing one of one or more nodes in the dynamic business network, one or more arcs in the dynamic business network and a piece of data associated with one of the one or more nodes and the one or more arcs in the dynamic business network.

11. The method of claim 1, wherein the dynamic business network is nonhomogeneous and has more than one different type of node.

12. The method of claim 9, wherein modifying one or more pieces of data in the dynamic business network further comprises applying a fitness function to modify the one or more pieces of data in the dynamic business network.

13. The method of claim 12, wherein the fitness function is a measure of consistency of data in the dynamic business network.

14. The method of claim 13, wherein applying the fitness function further comprises aggregating one or more fitness functions computed at one of a predetermined node, a predetermined arc or a predetermined piece of data of the dynamic business network to generate the fitness function.

15. The method of claim 1 further comprising adding new data to the created dynamic business network.

16. The method of claim 15, wherein adding new data further comprises one or more adding the new data to one of a predetermined node and a predetermined arc of the created dynamic business network and adding one of a new node and a new arc to the dynamic business network that contains the new data.

17. An apparatus, comprising:
a computer system having a processor, a memory and a plurality of lines of instructions configured to:
receive a static network specification, the static network specification having a plurality of nodes and a plurality of arcs, each node representing an entity associated with a business and each arc connecting two nodes in the static network and representing a type of interaction between the two nodes in the static network; and
create a dynamic business network based on the static network specification, the dynamic business network having a plurality of nodes that correspond to the plurality of nodes of the static network, a plurality of arcs that corresponds to the plurality of arcs of the static network and a plurality of time slices that each have a set of nodes and arcs for a time period derived from the plurality of nodes and arcs of the static network.

18. The apparatus of claim 17, wherein the computer system is further configured to one of: (a) receive the static network specification further comprises receiving a static network specification for a single static network, and (b) receive a static network specification for a plurality of static networks and combine the plurality of nodes and arcs for each static network into the plurality of nodes and arcs for the dynamic business network.

19. The apparatus of claim 17, wherein the static network specification further comprises at least one piece of data relating to more than one time period represented by the time slices in the dynamic business network.

20. The apparatus of 17, wherein the computer system is further configured to automatically assign the plurality of nodes and arcs of the static network specification to a predetermined time slice of the dynamic business network.

21. The apparatus of claim 17, wherein the computer system is further configured to apply one of a trend, decay and noise function to a piece of data in the dynamic business network.

22. The apparatus of claim 17, wherein each node represents one of a company, a group within a company, a product, product lines, a service, service lines, an organization, people, a team, capital, content, a school and a capital source.

23. The apparatus of claim 22, wherein each arc represents one of a business-to-business transaction, a partnerships, a merger, an acquisitions, an investment, employment, prior employment, a membership, a friendships, a colleague relationship, an attendance, a certification, a business to consumer transactions and an authorship.

24. The method of claim 17, wherein the static network further comprises one or of a business to business static network and a business to consumer static network.

25. The method of claim 17, wherein the computer system is further configured to modify one or more pieces of data in the dynamic business network.

26. The apparatus of claim 25, wherein the computer system is further configured to change one of one or more nodes in the dynamic business network, one or more arcs in the dynamic business network and a piece of data associated with one of the one or more nodes and the one or more arcs in the dynamic business network.

27. The apparatus of claim 17, wherein the dynamic business network is nonhomogeneous and has more than one different type of node.

28. The apparatus of claim 25, wherein the computer system is further configured to apply a fitness function to modify the one or more pieces of data in the dynamic business network.

29. The apparatus of claim 28, wherein the fitness function is a measure of consistency of data in the dynamic business network.

30. The apparatus of claim 29, wherein computer system is further configured to aggregate one or more fitness functions computed at one of a predetermined node, a predetermined arc or a predetermined piece of data of the dynamic business network to generate the fitness function.

31. The apparatus of claim 17, wherein the computer system is further configured to add new data to the created dynamic business network.

32. The apparatus of claim 31, wherein the computer system is further configured to add the new data to one of a predetermined node and a predetermined arc of the created dynamic business network and add one of a new node and a new arc to the dynamic business network that contains the new data.
